(19) United States
(12) Patent Application Publication
(10) Pub. No.: US 2008/0161367 A1
(43) Pub. Date: Jul. 3, 2008

(54) Insecticidal Mixtures

(75) Inventors: Dirk Voeste, Limburgerhof (DE); Henry Van Tuyl Cotter, Raleigh, NC (US)

Correspondence Address: HUTCHISON LAW GROUP PLLC, PO BOX 31686, RALEIGH, NC, 27612, US

(73) Assignee: BASF Aktiengesellschaft, Ludwigshafen (DE)

(21) Appl. No.: 11/909,193

(22) PCT Filed: Mar. 20, 2006
(86) PCT No.: PCT/EP2006/060888

§ 371 Date: Sep. 20, 2007

Related U.S. Application Data
(60) Provisional application No. 60/663,858, filed on Mar. 21, 2005.

(51) Int. Cl. A01N 51/00; A01P 7/04

(52) U.S. Cl. 514/365

(57) ABSTRACT

The present invention relates to plant-protecting active ingredient mixtures comprising fipronil and clothianidin having synergistically enhanced insecticical action by applying said mixtures to the plants or to the locus thereof and to a method for the protection of seeds comprising contacting the seeds before sowing and/or after pregermination with the aforementioned mixture. The invention also relates to seed comprising the aforementioned mixture and to the use of the aforementioned mixture for the protection of seeds from soil pests.

The present invention relates to plant-protecting active ingredient mixtures comprising fipronil and clothianidin having synergistically enhanced insecticical action by applying said mixtures to the plants or to the locus thereof and to a method for the protection of seeds comprising contacting the seeds before sowing and/or after pregermination with the aforementioned mixture. The invention also relates to seed comprising the aforementioned mixture and to the use of the aforementioned mixture for the protection of seeds from harmful insect pests.

One typical problem arising in the field of harmful insect control lies in the need to reduce the dosage rates of the active ingredient in order to reduce or avoid unfavorable environmental or toxicological effects whilst still allowing effective harmful insect pest control.

Another problem encountered concerns the need to have available seed protection agents which are effective against a broad spectrum of harmful insect pests.

There also exists the need for seed protection agents that combine knock-down activity with prolonged control, that is, fast action with long lasting action.

Another difficulty in relation to the use of seed protection pesticides is that the repeated and exclusive application of an individual pesticidal compound leads in many cases to a rapid selection of harmful insect pests, which have developed natural or adapted resistance against the active compound in question. Therefore there is a need for seed protection agents that help prevent or overcome resistance.

Another problem underlying the present invention is the desire for compositions that improve plants, a process which is commonly and hereinafter referred to as “plant health”. For example, advantageous properties that may be mentioned are improved crop characteristics including, but not limited to better emergence, increased crop yields, more favourable protein and/or content, more favourable amino acid and/or oil composition, more developed root system (improved root growth), tillering increase, increase in plant height, bigger leaf blade, less dead basal leaves, stronger tillers, greener leaf color, pigment content, photosynthetic activity, less fertilizers needed, less seeds needed, more productive tillers, earlier flowering, early grain maturity, less plant verse (lodging), increased shoot growth, enhanced plant vigor, increased plant stand or early germination; or a combination of at two or more of the aforementioned effects or any other advantages familiar to a person skilled in the art.

Thus, it was an object of the present invention to provide mixtures that confer plant health effects.

It was therefore an object of the present invention to provide a mixture, which provides good insecticidal activity against harmful insects and solve the problems of reducing the dosage rate and/or enhancing the spectrum of activity and/or combining know-down activity with prolonged control and/or to resistance management and/or plant health effects.

We have found that these objects are in part or in whole achieved by a mixture comprising, as active components, clothianidin and fipronil in synergistically effective amounts, which achieves markedly enhanced action against insecticidal plant pathogens compared to the control rates that are possible with the individual compounds, especially in the field of seed treatment.

The term seed treatment comprises all suitable seed treatment techniques known in the art, such as, but not limited to, seed dressing, seed coating, seed dusting, seed soaking, seed film coating, seed multilayer coating, seed encrusting, seed dripping, and seed pelleting.

These mixtures are also suitable for improving the health of plants when applied to plants, parts of plants, seeds, or at their locus of growth, preferably to plants and seeds, more preferably to seeds.

The synergistically enhanced action of the mixtures manifests itself, for example, in lower rates of application per active and broader spectrum of action. Such enhancements were not to be expected from the sum of the actions of the individual components. It has been found that the action of the mixture of clothianidin with fipronil goes far beyond the insecticidal action of the insecticide alone. It has been shown that the mixtures exhibit plant health effects (as outlined above) in the frame of the present invention. The term plant health comprises various sorts of improvements of plants that are not connected to the control of harmful insect pests with the said mixture of clothianidin and fipronil.

Clothianidin is an insecticide. See, for example, the Pesticide Manual, 13th Ed. (2003), The British Crop Protection Council, London, page 198.

Fipronil is an insecticide. See, for example, the Pesticide Manual, 13th Ed. (2003), The British Crop Protection Council, London, page 433.

The inventive mixtures are suitable for foliar application and soil uses in living crops of plants as well as, in particular, for dressing applications on seed.

The “seed” as used herein embraces seeds of all kinds (fruit, tubers, grains), cuttings, cut shoots and the like, in preferred embodiment true seeds. One particular field of application is the treatment of all kinds of seeds.

The protection of seeds can lead also to the protection of seedlings growing or derived from the seed.

The mixtures according to the invention inhibit or destroy the harmful insect pests, including but not limited to insects, that occur on plants or parts of plants (fruit, blossoms, leaves, stems, tubers, roots) of different crops of useful plants, while at the same time those parts of plants which grow later are also protected from attack by such harmful insect pests. Active ingredient mixtures have the special advantage of being highly active against harmful insect pests in the soil, which mostly occur in the early stages of plant development.

In addition to the mixtures, this invention also relates to a method of combating animal pests, which comprises contacting the animal pests, their habit, breeding ground, food supply, plant, plant propagation material (preferably seed), soil, area, material or environment in which the harmfull insects are growing or may grow, or the materials, plants, seeds, soils, surfaces or spaces, preferably plant propagation material (preferably seed), to be protected from harmful insect pest or infestation by the harmful insect pest with a mixture according to the invention, in any desired sequence or simultaneously, that is, jointly or separately.

In general, advantageous mixing ratios by weight of the active ingredients are clothianidin:fipronil, from 100:1 to 1:100. A preferred ratio clothianidin:fipronil is 10:1 to 1:10.

For seed treatment, the amount of either ingredient may range from 0.05 g to 10 kg a.i./100 kg seed. For example, amounts of Clothianidin and fipronil of 10 g: 1 g a.i./100 kg seed may be suitable.

When preparing the mixtures according to the invention, it is preferred to employ the pure active compounds, to which further active ingredients against harmful fungi or against harmful insect pests, including but not limited to insects and nematodes, or weeds, can be added.

Specifically, the mixtures according to the invention are suitable for controlling the following harmful insect pests:

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis;
beetles (Coleoptera), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Ortiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria;
dipterans (Diptera), for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia irritans, Haplodiplosis equestris, Hylemyia platura, Hypoderma lineata, Liriomyza sativae, Liriomyza trifolii, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa;
thrips (Thysanoptera), e.g. Dichromothrips corbetti, Frankliniella fusca, Frankliniella occidenfalis, Frankliniella tritici, Scirtothrips citri, Thrips oryzae, Thrips palmi and Thrips tabaci;
hymenopterans (Hymenoptera) such as ants, bees, wasps and sawflies, e.g. Athalia rosae, Atta cephalotes, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Dasymutilla occidentalis, Bombus spp., Vespula squamosa, Paravespula vulgaris, Paravespula pennsylvanica, Paravespula germanica, Dollchovespula maculata, Vespa crabro, Polistes, rubiginosa, Campodontus floridanus, and Linepitheum humile (Linepithema humile);
heteropterans (Heteroptera), e.g. Acrosternum hilare, Blissus leucopterus, Cyrtopeltis notatus, Dysdercus cingulatus, Dysdercus intermedius, Eurygaster integrceps, Euschistus impictiventris, Leptoglossus phyllopus, Lygus lineolaris, Lygus pratensis, Nezara viridula, Piesma quadrata, Solubea insularis and Thyanta perditor;
homopterans (Homoptera), e.g. Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus persicae, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Sogatella furcifera Trialeurodes vaporariorum, Toxoptera aurantiiand, and Viteus vitifolii;
termites (Isoptera), e.g. Calotermes flavicollis, Leucotermes flavipes, Reticulitermes flavipes, Reticulitermes lucifugus und Termes natalensis;
orthopterans (Orthoptera), e.g. Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus;
Arachnoidea, such as arachnids (Acarina), e.g. of the families Argasidae, Ixodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis, Tetranychidae spp. such as Tetranychus cinnabarinus, Tetranychus kanzawai, Tetranychus pacificus, Tetranychus telarius and Tetranychus urticae, Panonychus ulmi, Panonychus citri, and oligonychus pratensis;
Siphonatera, e.g. Xenopsylla cheopsis, Ceratophyllus spp.

In a further embodiment, the mixtures according to the invention are also suitable for the protection of seeds from soil pests and aphids especially from those selected from the following list of soil pests

millipedes (Diplopoda), hemiptera (homoptera and heteroptera), Orthoptera,
lepidopterans (Lepidoptera), for example Agrotis ipsilon, Agrotis segetum, Chilo ssp., Euxoa ssp., Momphidae, Ostrinia nubilalis, and Phthorimaea operculella,
beetles (Coleoptera), for example Agriotes lineatus, Agriotes obscurus, Aphthona euphoridae, Athous haemorrhoidalis, Atomaria linearis, Cetonia aurata, Ceuthorrhynchus assimilis, Ceuthorrhynchus napi, Chaetocnema tibialis, Ctenicera ssp., Diabrotica longicornis, Diabrotica speciosa, Diabrotica semi-punctata, Diabrotica virgifera, Limonius californicus, Melanotus communis, Ortiorrhynchus ovatus, Phyllobius pyri, Phyllophaga sp., Phyllophaga cuyabana, Phyllophaga triticophaga, Phyllopertha horticola, Phyllotreta nemorum, Phyllotreta striolata, Popillia japonica, Sitona lineatus and Sitophilus granaria,
flies (Diptera), for example Chrysomya bezziana, Chrysomya hominivorax, Chrysomya macellaria, Contarinia sorghicola, Cordylobia anthropophaga, Dacus cucurbitae, Dacus oleae, Dasineura brassicae, Delia antique, Delia coarctata, Delia platura, Delia radicum, Fannia canicularis, Gasterophilus intestinalis, Geomyza Tripunctata, Glossina morsitans, Haematobia irritans, Haplodiplosis equestris, Hypoderma lineata, Lucilia caprina, Lucilia cuprina, Lucilia sericata, Lycoria pectoralls, Mayetiola destructor, Muscina stabulans, Oestrus ovis, Opomyza florum, Oscinella frit, Pegomya hysocyami, Phorbia antiqua, Phorbia brassicae, Phorbia coarctata, Psila rosae, Rhagoletis cerasi, Rhagoletis pomonella, Tabanus bovinus, Tipula oleracea and Tipula paludosa,
thrips (Thysanoptera), e.g. Thrips simplex,
ants (Hymenoptera), e.g. Atta capiguara, Atta cephalotes, Atta laevigata, Atta robusta, Atta sexdens, Atta texana, Monomorium pharaonis, Solenopsis geminata and Solenopsis invicta, Pogonomyrmex ssp. and Pheidole megacephala,
termites (Isoptera), e.g. Coptotermes ssp,
springtails (Collembola), e.g. Onychiurus ssp.
and aphids such as homopterans (Homoptera), e.g. Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus persicae, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Sogatella furcifera Trialeurodes vaporariorum, Toxoptera aurantiiand, and Viteus vitifolii;

In particular, the inventive mixtures are suitable for combating harmful insect pests of the orders Coleoptera, Lepidoptera, Thysanoptera, Homoptera, Isoptera, and Orthoptera, wherein aphids, thrips, whiteflies, flea beetles, rootworms, seed maggots, wire-worms, white grubs, and grape calaspis are most preferred.

They are also suitable for controlling the following plant parasitic nematodes such as Meloidogyne, Globodera, Heterodera, Radopholus, Rotylenchulus, Pratylenchus and other genera.

For seed treatment purposes, suitable target seeds are various field crop seeds from monocotyledonous or dicotyledonous plants, conifers, fruit species, vegetables, spices and ornamental seed, for example corn/maize (sweet and field), durum wheat, soybean, wheat, barley, oats, rye, triticale, bananas, rice, cotton, sunflower, potatoes, pasture, alfalfa, grasses, turf, sorghum, rapeseed, Brassica spp., sugar beet, eggplants, tomato, lettuce, iceberg lettuce, pepper, cucumber, squash, melon, bean, dry-beans, peas, leek, garlic, onion, cabbage, carrot, tuber such as sugar cane, tobacco, coffee, turf and forage, cruciferous, cucurbits, grapevines, pepper, fodder beet, sugar beet, oil seed rape, pansy, impatiens, petunia and geranium, preferably cereals, maize, rice, canola, oil seed rape, cotton, potato, soybean, sugar beet, sunflower, and vegetables.

In addition, mixtures according to the invention may also be used in crops which tolerate the action of herbicides or fungicides or insecticides or nematicides owing to breeding, mutation and/or genetic engineering methods.

For example, mixtures according to the invention can be employed in transgenic crops which are resistant to herbicides from the group consisting of the sulfonylureas (EP-A-0257993, U.S. Pat. No. 5,013,659), imidazolinones (see for example U.S. Pat. No. 6,222,100, WO0182685, WO0026390, WO9741218, WO9802526, WO9802527, WO 04/106529, WO 05/20673, WO 03/14357, WO 03/13225, WO 03/14356, WO 04/16073), glufosinate-type (see for example EP-A-0242236, EP-A-242246) or glyphosate-type (see for example WO 92/00377) or in plants resistant towards herbicides selected from the group of cyclohexadienone/Aryloxyphenoxypropionic acid herbicides (U.S. Pat. No. 5,162,602, U.S. Pat. No. 5,290,696, U.S. Pat. No. 5,498,544, U.S. Pat. No. 5,428,001, U.S. Pat. No. 6,069,298, U.S. Pat. No. 6,268,550, U.S. Pat. No. 6,146,867, U.S. Pat. No. 6,222,099, U.S. Pat. No. 6,414,222) or in transgenic crop plants, for example cotton, with the capability of producing Bacillus thuringiensin toxins (Bt toxins) which make the plants resistant to certain pests (EP-A-0142924, EP-A-0193259).

Furthermore, mixtures according to the invention can be used also for the treatment of plants which have modified characteristics in comparison with existing plants, which can be generated for example by traditional breeding methods and/or the generation of mutants, or by recombinant procedures). For example, a number of cases have been described of recombinant modifications of crop plants for the purpose of modifying the starch synthesized in the plants (e.g. WO 92/11376, WO 92/14827, WO 91/19806) or of transgenic crop plants having a modified fatty acid composition (WO 91/13972).

The active ingredient mixtures can be used in the form of premix formulations or the active ingredients can be applied to the area, plant or seed to be treated simultaneously or in immediate succession, if desired together with formulation auxiliaries such as carriers, surfactants or other application-promoting adjuvants customarily employed in formulation technology. The use form depends on the particular purpose; it is intended to ensure in each case a fine and uniform distribution of the active compounds on the locus, to which the mixtures have to be applied. “Locus” means a habitat, breeding ground, plant, propagation material (preferably seed), soil, area, material or environment in which a pest or parasite is growing or may grow, preferably seed.

The active ingredient mixtures can be used in the form of premix formulations or the active ingredients can be applied to the area, plant or seed to be treated simultaneously or in immediate succession, if desired together with further carriers, surfactants or other application-promoting adjuvants customarily employed in formulation technology.

The formulations are prepared in a known manner, for example by extending the active compound with auxiliaries suitable for the formulation of agrochemicals, such as solvents and/or carriers, if desired surfactants (e.g. surfactants, adjuvans and/or dispersants), preservatives, antifoaming agents, anti-freezing agents, for seed treatment formulation also optionally colorants and/or binders and/or gelling agents. (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8).

Solvents/auxiliaries, which are suitable, are essentially:
water, aromatic solvents (for example Solvesso products, xylene), paraffins (for example mineral fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.
carriers such as ground natural minerals (e.g. kaolins, clays, talc, chalk) and ground synthetic minerals (e.g. highly disperse silica, silicates); emulsifiers such as nonionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose and ethylene oxide/propylene oxide block copolymers.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Powders, materials for spreading and dusts can be prepared by mixing or concomitantly grinding the active substances with a solid carrier.

Granules, for example coated granules, impregnated granules and homogeneous granules, can be prepared by binding the active ingredients to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

Stickers/adhesion agents can be added to improve the adhesion of the active materials on the seeds after treatment. Suitable adhesives are block copolymers EO/PO surfactants but also polyvinylalcoholsl, polyvinylpyrrolidones, polyacrylates, polymethacrylates, polybutenes, polyisobutylenes, polystyrene, polyethyleneamines, polyethyleneamides, polyethyleneimines (Lupasol®, Polymin®), polyethers, polyurethans and copolymers derived from these polymers.

In general, the formulations comprise from 0.01 to 95% by weight, preferably from 0.1 to 90% by weight, of the active ingredient. The active ingredients are employed in a purity of from 90% to 100%, preferably 95% to 100% (according to NMR spectrum).

Seed Treatment formulations may additionally comprise binders and optionally colorants.

Binders can be added to improve the adhesion of the active materials on the seeds after treatment. Suitable binders are block copolymers EO/PO surfactants but also polyvinylalcoholsl, polyvinylpyrrolidones, polyacrylates, polymethacrylates, polybutenes, polyisobutylenes, polystyrene, polyethyleneamines, polyethyleneamides, polyethyleneimines (Lupasol®), Polymin®), polyethers, polyurethans and copolymers derived from these polymers.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

The following are examples of formulations: 1. Products for direct application or for application after dilution with water for foliar application/for seed treatment purposes, these products can be applied diluted or undiluted.

An example of a gelling agent is carrageen (Satiagel®)

### A) Soluble Concentrates (LS)

10 parts by weight of the active compounds are dissolved in water or in a water-soluble solvent. As an alternative, wetters or other auxiliaries are added. The active compound dissolves upon dilution with water.

### B) Dispersible Concentrates (DC)

20 parts by weight of the active compounds are dissolved in cyclohexanone with addition of a dispersant, for example polyvinylpyrrolidone. Dilution with water gives a dispersion.

### C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

### D) Emulsions (ES)

40 parts by weight of the active compounds are dissolved in xylene with addition of calcium dodecylbenzenesulfonate and castor oil ethoxylate (in each case 5% strength). This mixture is introduced into water by means of an emulsifier (Ultraturax) and made into a homogeneous emulsion. Dilution with water gives an emulsion.

### E) Suspensions (FS)

In an agitated ball mill, 20 parts by weight of the active compounds are comminuted with addition of dispersant, wetters and water or an organic solvent to give a fine active compound suspension. Dilution with water gives a stable suspension of the active compound.

### F) Water-Dispersible Granules and Water-Soluble Granules (WG, SG)

50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.

### G) Water-Dispersible Powders and Water-Soluble Powders (SS, WS)

75 parts by weight of the active compounds are ground in a rotor-stator mill with addition of dispersant, wetters and silica gel. Dilution with water gives a stable dispersion or solution with the active compound.

Products to be applied undiluted for foliar application. For seed treatment purposes, these products can be applied diluted or undiluted

### H) Dustable Powders (DS)

5 parts by weight of the active compounds are ground finely and mixed intimately with 95% of finely divided kaolin. This gives a dustable product.

### I) Granules (GR, FG, GG, MG)

0.5 part by weight of the active compounds is ground finely and associated with 95.5% carriers. Current methods are extrusion, spray-drying or the fluidized bed. This gives granules to be applied undiluted.

Conventional seed treatment formulations include for example flowable concentrates FS, solutions LS, powders for dry treatment DS, water dispersible powders for slurry treatment WS, water-soluble powders SS and emulsion ES and EC. Application to the seeds is carried out before sowing, either directly on the seeds or after having pregerminated the latter.

The active ingredients can be used as such, in the form of their formulations or the use forms prepared therefrom, eg. in the form of directly sprayable solutions, powders, gels, suspensions or dispersions, emulsions, oil dispersions, pastes, dustable products, materials for spreading, or granules, microcapsules (CS), pellets or tablets, by means of spraying, atomizing, dusting, spreading or pouring. The use forms depend entirely on the intended purposes; it is intended to ensure in each case the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use products can be varied within relatively wide ranges. In general, they are from 0.01 to 80%, preferably from 0.1 to 50%.

Various types of oils, wetters or adjuvants may be added to the active ingredients, if appropriate just immediately prior to use. These agents usually are admixed with the agents according to the invention in a weight ratio of 1:100 to 100:1.

Depending on the desired effect, the application rates of the mixtures according to the invention are from 0.05 g/ha to 2 kg/ha, preferably from 50 to 1.5 kg/ha, in particular from 50 to 750 g/ha.

The application rates vary with the crop. In the treatment of seed, the application rate of the mixture is generally from 0.05 g to 10 kg of the mixture according to the invention per 100 kg of seeds. In general, rates from 0.05 g to 5 kg pesticidal agent per 100 kg of seeds, more desirably from 1 g to 0.1 kg per 100 kg of seeds are suitable.

In the control of harmful insect pests in the field of seed treatment, the application of the mixtures according to the invention is carried out by spraying or dusting or otherwise applying the mixture to the seeds or the soil (and thereby the seeds) after sowing.

In accordance with one variant, a further subject of the invention is a method of treating soil by the application, in particular into the seed drill: either of a granular formulation containing the two active ingredients in combination or as a composition, or of a mixture of two granular formulations, each containing one of the two active ingredients, with optionally one or more solid or liquid, agriculturally acceptable carriers and/or optionally with one or more agriculturally acceptable surfactants. This method is advantageously employed in seedbeds of cereal, maize, cotton and sunflower.

The invention also relates to the propagation products of plants, and especially the seed comprising, that is, coated with and/or containing, a mixture as defined above or a composition containing the inventive mixture or a mixture of compositions each providing one of the active ingredients.

The term “coated with and/or containing” generally signifies that the active ingredient is for the most part on the surface of the propagation product at the time of application, although a greater or lesser part of the ingredient may penetrate into the product, depending on the method of application. When the said propagation product is replanted, it may absorb the active ingredient. In effect, it can be stated for commercial purposes that the majority of the active ingredient is on the surface most of the time.

The seed comprises the inventive mixtures in an amount of from 0.05 g to 10 kg per 100 kg of seed.

The invention is further illustrated but not limited by the following examples.

### EXAMPLES

Each mixture partner has been evaluated separately at the same rates as used in the mixtures. Synergism was determined by comparing the expected biological effect on plant health or on disease control from the mixture based on the individual effects from the separate partners to the biological effect observed with the mixture. Abbott's formula has be used to make this comparison.

### Example 1

### Seed Treatment

Field corn seeds (Zea mays) were treated with a mixture of commercially available fipronil SC formulation (REGENT® 4 SC—479 g a.i./L) at rates of 0.005 g ai/100 kg seed with commercially available clothianidin formulation (PONCHO® 600—600 g a.i./L) at 0.05 g ai/100 kg seed. In addition, there was a treatment with each mixture partner at its respective solo rate. The carrier for all treatments was water. The respective formulation(s) and water were mixed in a 20 ml vial. Then 25 seeds were added, and the vial was vortexed. After treatment, seeds were allowed to dry. Seeds were placed on 3 pieces of moist filter paper in a Petri dish, one seed per dish. One day later, 5 2^{nd} instar Western corn rootworm larvae (Diabrotica virgifera virgifera) were added. Petri plates were incubated at 26° C., and insect mortality was evaluated 1 day later. Percent mortalities were calculated adjusting for any mortality in the untreated controls.

The expected percent mortality for the mixture was calculated based on the percent mortalities observed when each mixture partner was applied solo at the rate it was applied in the mixture using Abbott's formula as follows:

Expected percent mortality=(MP1+MP2)−(MP1*MP2)/100

where MP1=% mortality observed with mixture partner 1 and MP2=% mortality observed with mixture partner 2.

The actual response observed for the clothianidin plus fipronil mixture was greater than the expected response based on the responses observed when each partner was applied alone, demonstrating a synergistic insecticidal activity (Table 1).

TABLE 1

| | Expected mixture | Actual Mixture |
|---|---|---|
| | response | Response |
| | [% Larval | [% Larval |
| | Mortality] | Mortality] |
| Fipronil | — | 0 |
| (0.005 g a.i./100 kg | | |
| corn seed) | | |
| Clothianidin (0.05 g | — | 14 |
| a.i./100 kg corn seed | | |
| Clothianidin (0.05 g | 14 | 43 |
| a.i./100 kg corn | | |
| seed and | | |
| Fipronil (0.005 g | | |
| a.i./100 kg | | |
| corn seed) | | |

### Example 2

### Foliar Insecticidal Activity

The foliage of eggplant plants (Solanum melongena, variety Black Beauty) at the 4^{th} to 5^{th} true-leaf stage was treated with a mixture of commercially available fipronil SC formulation (REGENT® 4 SC, 479 g a.i./L-) at 0.05 ppm with commercially available clothianidin formulation (PONCHO® 600, 600 g a.i./L) at 0.05 ppm. In addition, there was a treatment with each mixture partner at its respective solo rate. Treatment was by spraying the leaves to near run-off. The carrier for all treatments was water. Two leaves on each of three plants were sprayed per treatment. After treatments dried, the two treated leaves were excised from each plant and placed on 3 pieces of moist filter paper in a Petri dish. Then 5 2^{nd} instar Colorado potato beetle larvae (Leptinotarsa decemlineata) were added to each dish for rep 1 and 2 and 10 larvae for rep 3. Insect feeding damage to the foliage was evaluated 3 days later. Percent reductions in insect feeding damage were calculated based on the untreated controls.

The expected reduction in feeding damage for the mixture was calculated based on the percent reductions observed when each mixture partner was applied solo at the rate it was applied in the mixture using Abbott's formula as follows:

Expected percent reduction in insect feeding injury=(MP1+MP2)−(MP1*MP2)/100

where MP1=% reduction observed with mixture partner 1 and MP2=% reduction observed with mixture partner 2.

The actual response observed for the clothianidin plus fipronil mixture was greater than the expected response based on the responses observed when each partner was applied alone demonstrating a synergistic insecticidal activity (Table 2).

TABLE 2

| | Expected mixture | Actual Mixture |
|---|---|---|
| | response | Response |
| | [% Reduction | [% Reduction |
| | in Insect | in Insect |
| | Feeding Injury] | Feeding Injury] |
| Fipronil (0.05 ppm) | — | 0 |
| Clothianidin (0.05 ppm) | — | 21 |
| Clothianidin (0.05 ppm) | 21 | 61 |
| and Fipronil (0.05 ppm) | | |

### Example 3

### Plant Health Activity

Soft red winter wheat seeds (Triticum aestivum, variety Coker 9663) were treated with a mixture of commercially available fipronil SC formulation (REGENT® 4 SC, 479 g a.i./L) at 0.5 g ai/100 kg seed with commercially available clothianidin formulation (PONCHO®) 600, 600 g a.i./L) at 5 g ai/100 kg seed. In addition, there was a treatment with each mixture partner at its respective solo rate. The carrier for all treatments was water. Each treatment was mixed in a 20 ml vial. Then 25 seeds were added, and the vial was vortexed. After treatment, seeds were allowed to dry. Plant growth pouches (18 cm×16.5 cm Cyg™ Germination Pouches, Mega-International) were watered with 20 ml water, and 4 seeds were placed in each growth pouch. Replication was 3×. Growth pouches were incubated at 25 C with 14 hours light per day and watered as needed. Shoot and root lengths and fresh weights were evaluated 7 days later.

Expected responses from the mixture were calculated based on the responses observed when each mixture partner was applied alone.

Percent effects for each of the mixture partners (MP1 and MP2) applied solo were calculated as follows:

MP1=(Control response−MP1 response)/Control response*100%

MP2=(Control response−MP2 response)/Control response*100%

Then, the expected % response for the mixture was calculated using Abbott's formula as follows:

E % response=(MP1+MP2)−(MP1*MP2)/100

Finally, the expected response for the mixture was calculated by applying the expected % response to the control response as follows:

Expected response=Control response−(Control response*E % response/100)

Wheat seeds treated with a clothianidin and fipronil mixture produced plant seedlings with greater mass for both roots and shoots and greater root and shoot lengths than expected based on the effects of the compounds when applied alone (Table 3). Thus the fipronil-clothianidin mixture applied to wheat seeds showed synergistic plant growth effects to both roots and shoots.

TABLE 3

| | Fipronil + Chlothianidin | |
|---|---|---|
| Wheat | (0.5 + 5 g ai/100 kg seed) | |
| Plant Growth | Expected Mixture Response | Actual Mixture |
| Measurement | based on Median Solo Effects | Response |
| Root Length (cm) | 13.8 | 15.0 |
| Root Mass (g) | 0.040 | 0.044 |
| Shoot Length (cm) | 15.0 | 15.5 |
| Shoot Mass (g) | 0.055 | 0.061 |

Evaluations were conducted on 12 seedlings per treatment, 3 reps with 4 seedlings each.

1-11. (canceled)

12. A composition comprising, clothianidin and fipronil in synergistically effective amounts.

13. The composition of claim 12, comprising clothianidin and fipronil in a weight ratio of from 100:1 to 1:100.

14. The composition of claim 13, further comprising an agronomically acceptable carrier.

15. The composition of claim 12, further comprising an agronomically acceptable carrier.

16. A method for the protection of seed comprising, contacting said seed before sowing or after pregermination or both with a composition comprising, clothianidin and fipronil in synergistically effective amounts.

17. The method of claim 16, wherein said synergistically effective amounts are from 100:1 to 1:100 w/w.

18. The method of claim 17, wherein said seed is contacted with said composition in an amount of from 0.05 g to 10 kg per 100 kg seed.

19. The method of claim 16, wherein said seed is contacted with said composition in an amount of from 0.05 g to 10 kg per 100 kg seed.

20. A method of combating harmful insect pests comprising, contacting animal pests, their habit, breeding ground, food supply, plant, seed, soil, area, material or environment in which the animal pests are growing or may grow, or the materials, plants, seeds, soils, surfaces or spaces to be protected from harmful insect pest attack or infestation with a composition comprising, clothianidin and fipronil in synergistically effective amounts in any desired sequence or simultaneously.

21. The method of claim 20, wherein said synergistically effective amounts are from 100:1 to 1:100 w/w.

22. A method of improving the health of plants comprising, applying simultaneously or in any desired sequence, that is, jointly or separately, a composition comprising, clothianidin and fipronil in synergistically effective amounts to plants, parts of plants, or the locus where plants grow.

23. The method of claim 22, wherein said synergistically effective amounts are from 100:1 to 1:100 w/w.

24. The method of claim 23, wherein the composition is applied in an amount of from 0.1 g/ha to 2 kg/ha.

25. The method of claim 22, wherein the composition is applied in an amount of from 0.1 g/ha to 2 kg/ha.

26. A seed comprising, a composition comprising, clothianidin and fipronil in synergistically effective amounts, in an amount of from 0.05 g to 10 kg of the composition per 100 kg of seed.

27. The seed of claim 26, wherein said synergistically effective amounts are from 100:1 to 1:100 w/w.

28. The seed of claim of claim 27, wherein said composition further comprises an agronomically acceptable carrier.

29. The seed of claim 26, wherein said composition further comprises an agronomically acceptable carrier.
